(19) United States
(12) Patent Application Publication
(10) Pub. No.: US 2024/0099324 A1
(43) Pub. Date: Mar. 28, 2024

(54) METHOD FOR PREPARING A CHOCOLATE PRODUCT

(71) Applicant: Cargill, Incorporated, Wayzata, MN (US)

(72) Inventors: Marc Frans Valentine TROCH, Antwerpen (BE); Ingrid Godelieve Liliane DE WITTE, 2100 (BE)

(73) Assignee: Cargill, Incorporated, Wayzata, MN (US)

(21) Appl. No.: 18/255,120

(22) PCT Filed: Dec. 1, 2020
(86) PCT No.: PCT/EP2020/084155

§ 371 Date: May 31, 2023

(51) Int. Cl. A23G 1/40; A23G 1/00; A23G 1/36

(52) U.S. Cl. CPC A23G 1/40; A23G 1/0003; A23G 1/36

(57) ABSTRACT

The invention relates to a for preparing a chocolate product, the process comprising: (a) providing a mixture, said mixture comprising: (i) one or more cocoa components; (ii) sucrose and, preferably, one or more reducing sugars; and (iii) water, wherein (1) said one or more cocoa components include cocoa butter and/or (2) said mixture comprises a chocolate compatible fat; (b) heating said mixture at a temperature of at least 90 #C, preferably of at least 100 #C, and/or heating said mixture at a temperature sufficiently high to effect evaporation of at least part of the water; and (c) cooling the mixture resulting from (b); and (d) optionally, subjecting the mixture to a treatment, which comprises subjecting the mixture to a temperature between 30 and 40 #C, preferably between 32 and 36 #C, more preferably between 33 and 35 #C for at least 1 minute and/or which 15 treatment comprises keeping the mixture under conditions such as to induce formation of type V crystals.

### FIELD OF THE INVENTION

The invention relates to a method for preparing a chocolate product. The invention further relates to chocolate products and uses thereof.

### BACKGROUND OF THE INVENTION

Methods for producing a chocolate product are known. Chocolate products produced in the conventional manner generally melt or become sticky at a temperature above 33° C. This is due to the circumstance that cocoa butter and other fats sometimes used with or in place of cocoa butter melt in the range of 30° C. to 35° C.

This property is disadvantageous under certain circumstances, for instance in hot climates or in food processing where the chocolate products may be exposed to relatively high temperatures.

In view of these problems, numerous attempts have been made to produce chocolate products having an increased heat resistance, i.e. which can withstand higher temperatures without melting or becoming sticky.

An early attempt has been described in U.S. Pat. No. 2,244,569A, which teaches hydrogenation of the chocolate to increase the resistance against high temperatures. Hydrogenation is a chemical process in which an unsaturated bond is converted into a saturated bond by the addition of hydrogen gas.

GB 1,000,159 teaches to increase the melting point by generating a sugar skeleton which is more resistant to collapse when the temperature exceeds the melting temperature of the fats in the chocolate. A process is taught wherein a first mass of chocolate containing amorphous sugar is mixed in fairly equal proportions with a second conched mass obtained in the usual way in which all the sugar is present in crystallized form. It is described that the development of heat resistance consists in storing the chocolate, in hermetically sealed wrappers, in a dry room where the temperature is kept constant at 25° C., for 20 to 30 days.

U.S. Pat. No. 5,160,760 describes the formation of a heat-resistant chocolate by dispersing and mixing a water-in-oil emulsion and a chocolate base material, wherein an oil phase in which a hydrophilic substance is contained is mixed and emulsified with an emulsifying agent to form said water-in-oil emulsion. Storage for about 20 days is carried out to contemplate increase in heat-resistance on time.

US 2018/0317517 gives an extensive overview of further attempts to prepare heat resistant chocolate. This document particularly refers to problems associated with the preparation of compounded or enrobed products such as heat resistant chocolate coated wafers, biscuits and the like, and proposes a method wherein water or a sorbitol solution are sprayed onto chocolate or a compound mass. Depending on the overall thickness of the desired heat resistant chocolate more layers of alternate spraying water or a polyol solution with the chocolate or compound are needed.

### SUMMARY OF THE INVENTION

In view of the above, there is need for a method enabling the preparation of a heat-resistant chocolate product in an efficient manner.

According to the invention, there is provided a preparing a chocolate product, the process comprising:
(a) providing a mixture, said mixture comprising:
   (i) one or more cocoa components;
   (ii) sucrose and, preferably, one or more reducing sugars; and
   (iii) water,
   wherein (1) said one or more cocoa components include cocoa butter and/or (2) said mixture comprises a chocolate compatible fat;
(b) heating said mixture at a temperature of at least 90° C., preferably of at least 100° C., and/or heating said mixture at a temperature sufficiently high to effect evaporation of at least part of the water; and
(c) cooling the mixture resulting from (b); and
(d) optionally, subjecting the mixture to a treatment, which comprises subjecting the mixture to a temperature between 30 and 40° C., preferably between 32 and 36° C., more preferably between 33 and 35° C. for at least 1 minute and/or which treatment comprises keeping the mixture under conditions such as to induce formation of type V crystals.

The invention further relates to a chocolate product obtained or obtainable by the method according to the invention.

Surprisingly, it was found that the method according the invention enables to obtain a heat resistant chocolate product. More in particular it was found that, after cooling of the mixture to a temperature of preferably below 40° C., heat resistance develops. The time within which the heat resistance develops may vary depending on the temperature and specific recipe and was generally found to be within a few minutes to several days. Without wishing to be bound by any scientific theory, this development of heat resistance is believed to be associated with the development of a structure of sugar which entraps the cocoa butter and/or chocolate compatible fat, thereby avoiding or mitigating its release at elevated temperatures.

The term heat resistant in the context of chocolate products is known in the art. As used herein this term preferably refers to a chocolate product which does not melt when stored in an oven at 40° C. for a period of 30 minutes.

The teaching according to the invention where a chocolate product is prepared in the presence of water goes against the existing teaching in the art that substantial amounts of water need to be avoided, when preparing chocolate.

It was also found that the mixture, prior to development of heat resistance, has good processability and may be moulded in a desired shape, be applied on a desired product and/or used to enrobe products.

It was further found that the period during which the processability of the mixture is optimal may be substantially extended by the use of a reducing sugar in the mixture of chocolate product. Advantageously, the mixture comprises one or more reducing sugars, preferably glucose and/or fructose.

Advantageously, the method comprises (d) subjecting the mixture resulting from (c) to a treatment, which treatment comprises subjecting the mixture to a temperature between 30 and 40° C., preferably between 32 and 36° C., more preferably between 33 and 35° C., for at least 1 minute and/or which treatment comprises keeping the mixture under conditions such as to induce formation of type V crystals. This treatment was found to result in a favourable texture of the end product, experienced by consumers as creamy, soft and pleasant. Advantageously, the treatment in (d) comprises agitating the mixture, preferably by stirring and/or kneading. This is found to accelerate the formation of the favourable texture.

Treatment in (d) was found to result in an increase of the viscosity, which, without wishing to be bound by any scientific theory, is believed to be associated with the solidification and/or crystallization of sucrose. Advantageously, the mixture comprises a reducing sugar or any other compound retarding such solidification and/or crystallization, to extend the time during which the mixture may be moulded or applied on or in a desired product in an optimal manner.

The product obtainable by the method according to the invention may be stored for an extended period of time at temperatures above 40° C. without melting or becoming sticky.

The taste and aromas of chocolate are found to be released in the mouth in a manner which is experienced by the user as forceful and very pleasant. Without willing be bound by any scientific theory, it is believed that the sugar structure breaks or is disintegrated in the mouth, thereby releasing the cocoa butter and/or chocolate compatible fat and other flavour components. Further, and without willing to be bound by any scientific theory, it is believed that the strong and pleasant flavour experienced by the user may be enhanced by compounds formed by Maillard reactions during heating (b) in the presence of a reducing sugar.

The invention further provides a chocolate product comprising:
(I) one or more cocoa components;
(II) sucrose; and
(III) one or more reducing sugars;
wherein (1) said one or more cocoa components include cocoa butter and/or (2) said mixture comprises a chocolate compatible fat;
and wherein the ratio of sucrose to said one or more reducing sugars is between 95:5 and 50:50, preferably between 90:10 and 60:40, on a weight basis.

The invention further provides a chocolate product comprising:
(I) one or more cocoa components;
(II) sucrose; and
(III) one or more reducing sugars;
wherein (1) said one or more cocoa components include cocoa butter and/or (2) said mixture comprises a chocolate compatible fat; and
wherein said one or more reducing sugars include one or more monosaccharides, and the ratio of sucrose to said one or more monosaccharides is between 95:5 and 50:50, preferably between 90:10 and 60:40, on a weight basis.

The invention further provides a chocolate product comprising:
(I) one or more cocoa components;
(II) sucrose; and
(III) one or more reducing sugars;
wherein (1) said one or more cocoa components include cocoa butter and/or (2) said mixture comprises a chocolate compatible fat; and
wherein said one or more reducing sugars include glucose, and the ratio of sucrose to said glucose is between 95:5 and 50:50, preferably between 90:10 and 60:40, on a weight basis.

The invention further relates to a method for preparing a food product, said method comprising preparing a chocolate product using the method according to the invention and/or providing a chocolate product obtainable by the method according to the invention or a chocolate product according to the invention; and using the chocolate product to prepare the food product.

The invention further provides a food product comprising a chocolate product according to the invention.

The invention further provides the use of a chocolate product according to the invention for the preparation of a food product.

### DETAILED DESCRIPTION OF THE INVENTION

### Chocolate Product

The invention provides chocolate products and methods for preparing a chocolate product. Whilst it is understood that the term chocolate may have legal definitions with respect to various amounts of various cocoa components, such as cocoa butter, cocoa solids, and whilst the method according to the invention enables to obtain products meeting such legal requirements, the method according to the invention is not limited to preparing such products. As used herein the term chocolate product refers to the product having the characteristics defined herein. In the method claims, the term chocolate product encompasses a product obtained or obtainable by the method as defined.

### (a) Providing the Mixture

The method according to the invention comprises providing a mixture, said mixture comprising:
(i) one or more cocoa components;
(ii) sucrose and, preferably, one or more reducing sugars; and
(iii) water,
wherein (1) said one or more cocoa components include cocoa butter and/or (2) said mixture comprises a chocolate compatible fat.

Preferably, the mixture provided in (a) has the preferred characteristics disclosed hereinbelow.

As used herein cocoa components refer to components derived from cocoa beans, such as for instance cocoa butter and cocoa solids.

Preferably, the cocoa components in the mixture include cocoa butter. In another preferred embodiment, the cocoa components in the mixture include cocoa butter and cocoa solids.

In another embodiment of the invention, the mixture comprises a chocolate compatible fat and one or more cocoa components. As used herein, the term the chocolate compatible fat encompasses any of the vegetable or other fats suitable for use in combination with or in place of cocoa butter. Exemplary chocolate compatible fats include for instance palm oil, in particular fractionated palm oil, illipe and shea nut butter, (fractionated and/or partially hydrogenated) soybean cotton or cottonseed oil, (fractionated and/or partially hydrogenated) lauric fat compounds. Said one or more other cocoa components preferably include cocoa butter and/or cocoa solids.

Cocoa components may be provided in any suitable manner, for instance by admixing cocoa butter, cocoa powder, cocoa liquor, cocoa mass, conched chocolate and/or any combination thereof to obtain the mixture.

Optimal results are obtained by providing at least part of the cocoa components by admixing cocoa liquor, cocoa mass and/or conched chocolate to obtain the mixture. As is understood by the skilled person, conched chocolate refers to the product obtained by a conching process.

Cocoa butter may be provided by admixing cocoa butter as such. It is also possible to provide cocoa butter by admixing cocoa butter-containing products, such as cocoa liquor, cocoa mass, and/or conched chocolate to obtain the mixture.

The cocoa components may be present in the mixture at any suitable concentration. Preferably, the mixture comprises at least 5 wt. %, preferably at least 10 wt. %, more preferably at least 20 wt. % of cocoa components with respect to the weight of the mixture, excluding water. There is no particular upper limit for the concentration of cocoa components in the mixture. Generally, the mixture comprises less than 60 wt. % of cocoa components with respect to the weight of the mixture, excluding water, for instance less than 50 wt. %, for instance less than 40 wt. % of cocoa components with respect to the weight of the mixture, excluding water. Preferably, the mixture comprises between 5 and 60 wt. %, preferably between 10 and 50 wt. %, more preferably between 20 and 40 wt. % of cocoa components with respect to the weight of the mixture, excluding water. Most preferably, the mixture comprises at least 32 wt. % of cocoa components, or at least 35 wt. % of cocoa components with respect to the weight of the mixture, excluding water, such as between 32 and 40 wt. % of cocoa components or between 35 and 40 wt. % of cocoa components with respect to the weight of the mixture, excluding water.

The cocoa butter may be present in the mixture at any suitable concentration. Preferably, the mixture comprises at least 5 wt. %, more preferably at least 10 wt. %, more preferably at least 15 wt. % of cocoa butter with respect to the weight of the mixture, excluding water. There is no particular upper limit for the concentration of cocoa butter in the mixture. Generally, the mixture comprises less than 40 wt. % of cocoa butter with respect to the weight of the mixture excluding water, for instance less than 35 wt. %, for instance less than 30 wt. % of cocoa butter with respect to the weight of the mixture, excluding water. Preferably, the mixture comprises between 5 and 40 wt. % of cocoa butter, preferably between 10 and 35 wt. % of cocoa butter, more preferably between 15 and 30 wt. % of cocoa butter with respect to the weight of the mixture, excluding water.

The mixture comprises sucrose. As is well known to the skilled person, sucrose is a disaccharide, a molecule composed of two monosaccharides: glucose and fructose.

The mixture comprises, optionally, one or more reducing sugars. As is well known to the skilled person, a reducing sugar is any sugar that is capable of acting as a reducing agent, because it has a free aldehyde group or a free ketone group. All monosaccharides are reducing sugars. Glucose and fructose are exemplary monosaccharides.

Sucrose may be present in the mixture at any suitable concentration. Preferably, the mixture comprises at least 25 wt. % of sucrose with respect to the weight of the mixture, excluding water, preferably at least 35 wt. %, more preferably at least 40 wt. % sucrose with respect to the weight of the mixture, excluding water. Increasing the percentage of sucrose in the mixture is found to have the advantage of further enhancing the development of heat resistance. There is no particular upper limit for the concentration of sucrose in the mixture. Generally, the mixture comprises less than 70 wt. % of sucrose with respect to the weight of the mixture excluding water, for instance less than 65 wt. %, for instance less than 60 wt. % with respect to the weight of the mixture, excluding water. Preferably, the mixture comprises between 25 and 70 wt. % of sucrose, preferably between 35 and 65 wt. %, more preferably between 40 and 60 wt. % of sucrose with respect to the weight of the mixture, excluding water.

Preferably, the mixture comprises one or more reducing sugars. The presence of a reducing sugar has been found to extend the time during which processability of the mixture remains optimal after cooling. Without wishing to be bound by any scientific theory this effect is believed to be associated with the interaction of the reducing sugar with the crystallization of sucrose. Furthermore, the presence of a reducing sugar is believed to enhance the taste experience. Without wishing to be bound by any scientific theory, this effect is believed to be associated with the occurrence of Maillard reactions between the reducing sugar and amino acids from originating from the cocoa components, when the mixture is exposed to temperature during heating. Preferably, the one or more reducing sugars include one or more monosaccharides, for instance one or more monosaccharides selected from the group consisting of glucose and fructose. More preferably, the one or more reducing sugars include glucose.

The sucrose and one or more reducing sugars can be applied at any suitable ratio. Preferably, the ratio of sucrose to one or more reducing sugars in the mixture is between 95:5 and 50:50, more preferably between 90:10 and 60:40, on a weight basis. Thus, as used herein, the weight of the one or more reducing sugars refers to the sum weight of the reducing sugars.

Preferably, the ratio of sucrose to one or more monosaccharides is between 95:5 and 50:50, more preferably between 90:10 and 60:40, on a weight basis. Thus, as used herein the weight of the one or more monosaccharides refers to the sum weight of the monosaccharides.

Preferably, the ratio of sucrose to glucose is between 95:5 and 50:50, more preferably between 90:10 and 60:40, on a weight basis.

The mixture in (a) comprises water. The amount of water in the mixture provided in (a) may vary between wide ranges. Preferably, the amount of water is chosen to enable dissolution of all sucrose and reducing sugar at the temperature at which the mixture is heated. The skilled person is able to determine such amount. The concentration of water in the mixture provided in (a) may for instance be at least 5 wt. % with respect of the weight of the mixture, preferably at least 10 wt. %, more preferably at least 15 wt. %, more preferably at least 20 wt. % with respect to the weight of the mixture. There is no particular upper limit for the amount of water in the mixture provided in (a). If the amount of water is very high, it will require more energy to evaporate water to a desired extend which makes the process less economical. Preferably, the amount of water in the mixture provided in (a) is less than 60 wt. %, with respect to the weight of the mixture, preferably, less than 50 wt. %, more preferably less than 40 wt. % with respect to the weight of the mixture.

The skilled person will realize that the water may be provided by admixing water into the mixture as such, or as part of any suitable water containing composition, such as for instance milk.

Optionally, the mixture comprises milk components. The concentration of milk components in the mixture may for instance be between 10 and 30 wt. % with respect to the weight of the mixture, excluding water.

In a preferred embodiment, the mixture in further comprises a sucrose ester. This compound was found to further improve the structure and appearance and stickiness during processing.

The mixture may further comprise flavour and/or color components, for instance vanilla aroma.

The skilled person will understand that the preparation of the mixture is not limited to any sequence of admixing of ingredients. For instance, it is possible to mix the ingredients at once. In a preferred embodiment the method comprises mixing and heating water and/or milk, sucrose and the optional reducing sugar first, for instance to a temperature above 65° C., preferably above 80° C., and followed by adding the cocoa components and the optional chocolate compatible fat. In a preferred embodiment sucrose is not added during cooling. The skilled person will understand that (a) and (b) may be effected in one stage.

### (b) Heating the Mixture

The method according to the invention comprises heating the mixture.

Heating may be carried out in any suitable manner such as to effect evaporation of at least part of the water such that, upon cooling, saturation is sufficient that solidification and/or crystallization of sugars can occur. Based on this teaching provided herein, the skilled person will be able to establish this amount by routine experimentation. Water may for instance be evaporated resulting in a mixture comprising less than 25 wt. % of water with respect to the weight of the mixture, preferably between 4 and 20 wt. %, more preferably between 5 and 18 wt. %, most preferably between 6 and 15 wt. % with respect to the weight of the mixture.

It is possible to perform the heating at reduced pressure, such that evaporation occurs at a lower temperature. Preferably, heating is carried out at a temperature of at least 90° C., preferably of at least 100° C. This was found to result in a chocolate product having an excellent flavour. It is hypothesized that this may be due to Maillard reactions occurring at elevated temperature between amino acids present in the cocoa components and reducing sugar.

Heating may be effected for any suitable time. It is observed that an increased heating time improves the flavour of the end product. Heating the mixture in (b) may for instance be effected for a period of at least 1 minute, for instance between 1 and 10 minutes.

Heating may be effected in any suitable vessel known for this purpose. An open vessel is advantageously used.

Preferably, the method according to the invention comprises agitating the mixture during at least part of the heating, for instance by stirring. It was found that during the heating and cooling process cocoa butter and other fats tend to separate and float on the mixture. Mechanically agitating, such as by stirring enables to keep the mixture homogeneous.

### (c) Cooling the Mixture

The method according to the invention comprises cooling the mixture resulting from (b).

Preferably, the mixture is cooled to a temperature below 40° C., more preferably below 30° C. Preferably, the method according to the invention comprises mechanically agitating the mixture during at least part of said cooling, for instance by stirring.

Cooling may be effected in any suitable manner. Cooling may for instance be effected in a vessel. Cooling may also be effected by contacting the mixture with a cooling surface, for instance a cooling table or a worktop, for instance a marble worktop. A cooling tunnel may also be used.

Advantageously, contacting the mixture with a cooling surface is effected such that the temperature of the mixture is decreased to between 15 and 60° C., preferably between 20 and 50° C.

In a preferred embodiment, cooling comprises, in a first stage, cooling the mixture to a temperature of between 60 and 85° C., wherein said first stage is effected in a vessel and wherein the mixture is mechanically agitated, for instance by stirring, during at least part of said first stage.

Preferably, cooling comprises, in a second stage, contacting the mixture with a cooling surface, preferably a cooling table or a worktop, for instance a marble worktop. It is also possible to use a cooling tunnel in the second stage.

The skilled person will appreciate that during cooling as disclosed enables the mixture to be in kept or obtained in the form of a dough.

In an embodiment of the invention, one or more reducing sugars, preferably one or more monosaccharides, preferably glucose, are added to the mixture during cooling.

### (d) Treatment

Preferably, the method according to the invention comprises subjecting the mixture resulting from (c) to a treatment, which comprises subjecting the mixture to a temperature between 30 and 40° C., preferably between 32 and 36° C., more preferably between 33 and 35° C. for at least 1 minute and/or which treatment comprises keeping the mixture under conditions such as to induce formation of type V crystals. Advantageously, the treatment in (d) comprises agitating the mixture, preferably by stirring and/or kneading. This treatment was found to result in a favourable texture of the end product, experienced by consumers as creamy, soft and pleasant.

It is well known that cocoa butter can crystallize into different forms referred to as forms I to VI and that form V preferred, as this results in a texture which is appreciated by the consumers. Form V is preferentially formed at a temperature of around 34° C. Reference is for instance made to Stephen Beckett, The Science of Chocolate, RSC Publishing 200, p. 107-116. In order to obtain this preferred form, in the art generally a treatment is applied, referred to as tempering.

Whilst this treatment as such is known, the preferred embodiment according to the invention involving (d) enables to obtain the combination of a heat resistant chocolate with a very creamy soft and pleasant texture in an efficient manner.

Preferably, in (d), the temperature of the mixture is between 30 and 40° C., preferably between 32 and 36° C., more preferably between 33 and 35° C., for a period of between 1 and 30 minutes. Preferably, in (d), the temperature of the mixture is between 30 and 40° C., preferably between 32 and 36° C., more preferably between 33 and 35° C., for a period of at least 2 minutes.

### (e) Aging

It was found that, after (c) and/or (d) heat resistency naturally develops. Accordingly, the said method preferably comprises aging the mixture resulting from (c) and/or (d) to obtain a heat resistant chocolate product.

Preferably the heat resistant chocolate product does not melt when kept in an oven at 40° C. for a period of 30 minutes, more preferably the heat resistant product does not melt when kept in an oven at 50° C., more preferably at 60° C., more preferably at 70° C. for a period of 30 minutes.

Aging is found to happen naturally at a temperature below 40° C., preferably below 35° C., more preferably below 30° C. such as room temperature. Accordingly, the method according to the invention preferably comprises: (e) subjecting the mixture resulting from (c) and/or (d) to aging in which the temperature of the mixture is below 40° C., preferably below 35° C., more preferably below 30° C. for a period of at least 2 hours; and/or in which wherein the mixture resulting from (c) and/or (d) is subjected kept at a temperature sufficiently low and a period sufficiently long such that a heat resistant chocolate product is obtained.

In practice, aging does not require a specific treatment. It can be effect by storage of the product.

### Reheating

It was found that, if the product resulting from (c) or (d) is reheated to a temperature above 80° C., (c) and/or (d) may be repeated with good results. Accordingly, in a preferred embodiment, the method according to the invention comprises: heating the product resulting from (c) and/or (d) to a temperature of above 80° C. Preferably, this embodiment further comprises repeating (c) and/or (d).

It was also found that, if aged product resulting from (e) is reheated to a temperature of above 95° C., preferably of at least 100° C. (c) and/or (d) may be repeated with good results. Accordingly, in a preferred embodiment, the method according to the invention comprises reheating the product resulting from (e) to a temperature of above 95° C., preferably of at least 100° C. Preferably, this embodiment further comprises repeating (c) and/or (d).

### Storing and Transporting

It was found that a chocolate product obtained or obtainable by (a), (b) and (c) may be effectively stored and/or transported, and still be used to obtain a heat resistant product. Accordingly, the invention further relates to a method for preparing and storing or transporting a chocolate product, the process comprising:
(a) providing a mixture, said mixture comprising:
(i) one or more cocoa components;
(ii) sucrose and, preferably, one or more reducing sugars; and
(iii) water,
wherein (1) said one or more cocoa components include cocoa butter and/or (2) said mixture comprises a chocolate compatible fat;
(b) heating said mixture at a temperature of at least 90° C., preferably of at least 100° C., and/or heating said mixture at a temperature sufficiently high to effect evaporation of at least part of the water; and
(c) cooling the mixture resulting from (b) to a temperature between 50 and 90° C., preferably to a temperature between 60 and 85° C., more preferably to a temperature between 65 and 80° C.,
wherein the method further comprises storing the mixture obtained in (c) at a temperature between 50 and 90° C., preferably to a temperature between 60 and 85° C., more preferably to a temperature between 65 and 80° C.

The invention also relates to a chocolate product, obtainable by this process.

### Chocolate Products

The invention further provides chocolate products. The chocolate products advantageously are heat resistant or are useful intermediates to obtain heat resistant chocolate products.

The invention provides a chocolate product obtainable by the methods according to the invention.

The invention further provides a chocolate product comprising one or more reducing sugars. It was found that the presence of one or more reducing sugars extend the period during which the processability is optimal.

Accordingly, the invention provides a chocolate product comprising
(I) one or more cocoa components;
(II) sucrose; and
(III) one or more reducing sugars
wherein (1) said one or more cocoa components include cocoa butter and/or (2) said mixture comprises a chocolate compatible fat; and
wherein the ratio of sucrose to said one or more reducing sugars is between 95:5 and 50:50, more preferably between 90:10 and 60:40, on a weight basis.

Preferably, the one or more reducing sugars include one or more monosaccharides. Accordingly, the invention further provides a chocolate product comprising:
(I) one or more cocoa components;
(II) sucrose; and
(III) one or more reducing sugars,
wherein (1) said one or more cocoa components include cocoa butter and/or (2) said mixture comprises a chocolate compatible fat; and
wherein said one or more reducing sugars include one or more monosaccharides, and the ratio of sucrose to said one or more monosaccharides is between 95:5 and 50:50, more preferably between 90:10 and 60:40, on a weight basis.

Preferably, the one or more monosaccharides include glucose. Accordingly, the invention further provides a chocolate product comprising
(I) one or more cocoa components;
(II) sucrose; and
(III) one or more reducing sugars,
wherein (1) said one or more cocoa components include cocoa butter and/or (2) said mixture comprises a chocolate compatible fat; and
wherein said one or more reducing sugars include glucose and the ratio of sucrose to said glucose is between 95:5 and 50:50, more preferably between 90:10 and 60:40, on a weight basis.

Preferably, the chocolate products according to the invention comprise water, for instance between 1 and 20 wt. %, preferably between 2 and 15 wt. %, more preferably between 3 and 12 wt. %, more preferably between 4 and 10 wt. % of water with respect to the weight of the chocolate product.

The composition of the chocolate products according to the invention may vary between wide ranges.

Preferably, the chocolate products according to the invention comprise between 5 and 60 wt. %, preferably between 10 and 50 wt. %, more preferably between 20 and 40 wt. % of cocoa components with respect to the weight of the chocolate product. Most preferably, the mixture comprises at least 32 wt. % of cocoa components, or at least 35 wt. % of cocoa components with respect to the weight of the chocolate product.

Preferably, the chocolate products according to the invention comprise between 5 and 40 wt. % of cocoa butter, preferably between 10 and 35 wt. % of cocoa butter, more preferably between 15 and 30 wt. % of cocoa butter with respect to the weight of the chocolate product.

Preferably, the chocolate products according to the invention comprise between 25 and 70 wt. % of sucrose, preferably between 35 and 65 wt. %, more preferably between 40 and 60 wt. % of sucrose with respect to the weight of the chocolate product.

Preferably, the chocolate products according to the invention are heat resistant. Preferably, the chocolate products according to the invention do not melt when kept in an oven at 40° C., more preferably at 50° C., more preferably at 60° C., more preferably at 70° C. for a period of 30 minutes.

Preferably, the cocoa components in the chocolate product include cocoa butter. It is also possible that the chocolate product comprises a chocolate compatible fat. As used herein, the term the chocolate compatible fat encompasses any of the vegetable or other fats suitable for use in combination with or in place of cocoa butter. Exemplary chocolate compatible fats include for instance palm oil, in particular fraction palm oil, illipe and shea nut butter, (fractionated and/or partially hydrogenated) soybean cotton or cottonseed oil, (fractionated and/or partially hydrogenated) lauric fat compounds. Said one or more other cocoa components preferably include cocoa butter and/or cocoa solids.

Preferably, the chocolate products according to the invention are obtainable by the methods according to the invention.

### Food Products and Uses—Preparation of Food Products

The chocolate products according to the invention have good processability and are very suitable for the use in food products. They are particularly suitable to cover and/or enrobe food products.

Accordingly, the invention also provides a food product comprising a chocolate product according to the invention. Preferably, the food product is a bakery product (for instance a biscuit or a cake), a dairy product (for instance a milk or yoghurt containing the chocolate product according to the invention), a moulded product, and/or a confectionery product, such as for instance a candy bar.

The invention further provides a food product, which comprises an edible substrate and the chocolate product, wherein the chocolate product is disposed on the edible substrate; and/or wherein the chocolate product at least partly enrobes the edible substrate.

The invention further provides the use of the chocolate product according to the invention for the preparation of a food product, for instance, bakery product, a dairy product; and/or a confectionery product, for instance a candy bar.

The invention further provides a method for preparing a food product, said method comprising preparing a chocolate product using the method according to the invention, providing a chocolate product obtainable by the method according to the invention; and/or providing a chocolate product according to the invention; and using the chocolate product to prepare the food product.

In a preferred embodiment, the food product is a moulded chocolate product and the method comprises feeding the chocolate product (for instance the mixture resulting from (c) and/or (d)) in a mould, optionally followed by aging the product to obtain a heat resistant chocolate product.

In another preferred embodiment, the food product comprises an edible substrate, and the method comprises applying the chocolate product (for instance the mixture resulting from (c) and/or (d)) on the edible substrate, optionally followed by aging the chocolate product to obtain a heat resistant chocolate product.

In another preferred embodiment, the method comprises incorporating the chocolate product into the food product.

Preferably, the temperature of said chocolate product is kept between 30 and 40° C. during or after said moulding, applying, and/or incorporating, for instance by using a heating lamp.

The invention will now be illustrated with reference to the following examples, without being limited thereto.

### EXAMPLES

### Examples—Basic Exemplary Procedure

The following basic procedure was applied in the examples. The exact amounts of ingredients have been indicated in the tables. Deviations from the basic procedures have been indicated as well.

Measurement of the temperature was performed using a candy thermometer (CDN®).

First, water, sugar (sucrose) and, if applicable, glucose, were mixed and heated under agitation to a temperature of approximately 70-80° C. Furthermore, in most instances, a few grams of trisuc (Liquid trisuc 73% provided by Belgosuc, a partly inverted sugar syrup obtained through acid hydrolysis of an aqueous solution of sucrose) and sucrose ester (SP-70 from Sisterna®) were added in the beginning of the processes in order to make the entire mixture easier to process.

As soon as the mixture had attained a temperature of approximately 70-80° C., cocoa mass (this is a thick paste of finely ground cocoa beans and consists entirely or essentially of cocoa butter and cocoa powder) and, if applicable other cocoa components, were added and the mixture comprising cocao was heated further under agitation to a temperature varying between 100-115° C. (depending on the recipe—see tables). In order to prevent burning of the mixture comprising cocoa, the heating to 100-115° C. took place in an open copper kettle.

During the heating, the cocoa butter was found to separate from the cocoa liquor and to float on the mixture. The temperature at which this takes place is dependent on the amount of cocoa butter. This temperature was usually above 100° C. Upon the observation of the separation of cocoa butter and floating thereof, most of the water had evaporated, and the heat source was turned off. During the subsequent cooling down to a temperature of about 80° C., the mixture was agitated such as to mix the cocoa butter into the mixture and to obtain a homogeneous mixture.

Subsequently, the chocolate product was forcibly cooled down to approximately by pouring the chocolate product onto a worktop, in most cases to a temperature of between 40 and 45° C.

In order to improve the taste of the chocolate product, the chocolate product was kneaded in a mechanical mixer for approximately 3 minutes. At that time often a structure with strings was observed. The temperature was then between 30 and 40° C.

Then, the chocolate product was, using a piping bag, used to fill moulds to make chocolate, to cover biscuits, candy bars, coconut mass, and to form a layer between biscuits. Sometimes a heating lamp was used to extend the time during which the processability of the chocolate remained optimal. The resulting products were then maintained at room temperature for a period varying between a few hours and approximately two days in order to give it enough time to develop heat resistance.

### Heat Resistance Test

Heat resistance was tested by putting the chocolate product in an oven at 40° C. and keeping it at this temperature for 30 minutes. The temperature was then increased in steps of 5° C., with a period of 30 minutes between each step. The temperature at which melting was observed was reported.

### Ether Test

A glass (approximately 5 cl) was filled with ether in which the chocolate was immersed at room temperature.

In case of convention chocolate (milk chocolate of Côte d'Or) the onset of dissolution of fat was observed after 30 seconds. After 50 minutes, the conventional chocolate was found to be completely disintegrated/dissociated. This supports that cocoa butter, which is soluble in ether, forms the matrix of conventional chocolate.

Chocolates according to the present invention remained were still completely intact after 50 minutes. This confirms that cocoa butter is prevented from dissolving in ether, presumably since it is entrapped in a sugar structure.

### Example 1

Chocolate products were prepared based on the recipes indicated in table 1:

TABLE 1

| | Example 1-1 | Example 1-2 |
|---|---|---|
| water (g) | 550 | 550 |
| sugar (sucrose) (g) | 640 | 640 |
| glucose (g) | 0 | 0 |
| sucrose ester (g) | 2.9 | 2.9 |
| trisuc (g) | 2.5 | 2.5 |
| cocoamass* (g) | 362 | 362 |
| aroma/vanilla (g) | | 1.2 |
| sum ingredients prior to | 1557.4 | 1558.6 |
| heating (g) | | |
| Boiling temperature (° C.) | 106 | 106 |

*CM-CAL-552 from Callebaut ®

The products can withstand a temperature of 75° C. and do not dissolve in ether.

### Example 2

Chocolate products were prepared using glucose in addition to the other ingredients. Pure chocolate as well as milk chocolate (example 2-4) were prepared. The recipes have been indicated in Table 2.

It was found that the use of glucose substantially improved the processability of the chocolate.

The products can withstand a temperature of 75° C. and do not dissolve in ether.

TABLE 2

| | Example | Example | Example | Example |
|---|---|---|---|---|
| | 2-1 | 2-4 | 2-3 | 2-4 |
| water (g) | 550 | 550 | 550 | 550 |
| sugar (sucrose) (g) | 550 | 550 | 550 | 550 |
| glucose (g) | 90 | 90 | 90 | 90 |
| sucrose ester (g) | 2.9 | 0 | 2.9 | 2.9 |
| trisuc (g) | 2.5 | 2.5 | 0 | 2.5 |
| cocoamass* (g) | 362 | 362 | 362 | 180 |
| milk powder (g) | | | | 180 |
| aroma/vanilla (g) | 1.2 | | | |
| sum ingredients | 1558.6 | 1554.5 | 1554.9 | 1555.4 |
| prior to heating (g) | | | | |
| Boiling temperature | 106° C. | 106° C. | 106° C. | 102° C. |

*CM-CAL-552 from Callebaut ®

### Example 3

Chocolate products were prepared with the amount of glucose used being varied. The recipes have been indicated in Table 3.

TABLE 3

| | Example 3-1 | Example 3-2 | Example 3-3 |
|---|---|---|---|
| water (g) | 550 | 550 | 550 |
| sugar (sucrose) (g) | 580 | 550 | 460 |
| glucose (g) | 60 | 90 | 180 |
| sucrose ester (g | 2.9 | 2.9 | 2.9 |
| trisuc (g) | 2.5 | 2.5 | 2.5 |
| cocoamass* (g) | 362 | 362 | 362 |
| aroma/vanilla (g) | 1.2 | 1.2 | |
| sum ingredients | 1558.6 | 1558.6 | 1557.4 |
| prior to heating (g) | | | |
| Boiling temperature | 106° C. | 106° C. | 106° C. |

*CM-CAL-552 from Callebaut ®

The products can withstand a temperature of 75° C. and do not dissolve in ether.

### Example 4

Chocolate products were prepared with the amount of water used being varied. The recipes have been indicated in Table 4.

An electric stainless steel vessel was used instead of a copper pot. Table 4 indicates the sum of the warming up time and heating time, as well as the weight of the mixture prior to heating and the weight of the mixture after having been poured on the work top. This enabled to calculate the amount of water remaining after heating in examples 4-1 and 4-3. It was found that about 10 wt. % of water remained in the mixture after heating.

Further, it was observed that the product made using the highest amount of water (500 g) has a more intense taste. It is hypothesized that this is due to the longer heating time which enables Maillard reactions to proceed for a longer time.

The products can withstand a temperature of 75° C. and do not dissolve in ether.

TABLE 4

| | Example | Example | Example |
|---|---|---|---|
| | 4-1 | 4-2 | 4-3 |
| water (g) | 150 | 200 | 500 |
| sugar (sucrose) (g) | 550 | 550 | 550 |
| glucose (g) | 90 | 90 | 90 |
| sucrose ester (g) | 2.9 | 2.9 | 2.9 |
| trisuc (g) | 2.5 | 2.5 | 2.5 |
| cocoamass* (g) | 362 | 362 | 362 |
| sum ingredients prior to | 1157.4 | 1207.4 | 1507.4 |
| heating (g) | | | |
| sum ingredients after | 1114 | | 1123 |
| heating (g) | | | |
| Water remaining in mixture | 106.6 (9.6%) | | 116.4 (10.4%) |
| after, calculated (g) | | | |
| Heating time + warming up | 7 | 20 | 35 |
| time (min) | | | |
| Boiling temperature | 106° C. | 110° C. | 106° C. |

*CM-CAL-552 from Callebaut ®

### Example 5

Couvertures were prepared using the recipes as indicated in Table 5.

The resistance against heat has been indicated in Table 5 as well. The products do not dissolve in ether.

TABLE 5

| | Example | Example | Example | Example |
|---|---|---|---|---|
| | 5-1 | 5-2 | 5-3 | 5-4 |
| | (milk) | (pure) | (pure) | (white) |
| water (g) | 550 | 550 | 550 | 550 |
| sugar (sucrose) (g) | 50 | 0 | 120 | 0 |
| glucose (g) | 90 | 90 | 90 | 90 |
| sucrose ester (g) | 2.9 | 2.9 | 2.9 | 2.9 |
| trisuc (g) | 2.5 | 2.5 | 2.5 | 2.5 |
| 823-E1- | 912 | | | |
| U68/callebaut*) | | | | |
| 811-E1- | | 912 | 912 | |
| U6/Callebaut**) | | | | |
| W2-E1- | | | | 912 |
| U68/Callebaut** ) | | | | |
| sum ingredients | 1607.4 | 1557.4 | 1677.4 | 1557.4 |
| prior to heating (g) | | | | |
| Boiling temperature | 111° C. | 107° C. | 107° C. | 104° C. |
| Heat resistency | 75° C. | 65° C. | 75° C. | 60° C. |
| (max temperature) | | | | |

*)42.0% sugar (sucrose), 24,0% cocoa butter, 22.5% milk powder (whole milk), 11.0% cacao mass,
**)43.0% sugar (sucrose), 43.0% cocoa mass, 13.0% cocoa butter
***)46.5% sugar (sucrose), 29.5% cocoa butter, 23.5% milk powder (whole milk)

### Example 6

Further, chocolate products were prepared using the recipes indicated in Table 6.

The products can withstand a temperature of 75° C. and do not dissolve in ether.

Example 6-2 was performed twice, once in accordance with the standard basic procedure, and once wherein the mixture was entirely cooled in the pot instead of by pouring the product on the worktop. In both cases a heat resistant product was obtained.

TABLE 6

| | Example | Example | Example | Example |
|---|---|---|---|---|
| | 6-1 | 6-2 | 6-3 | 6-4 |
| water (g) | 220 | 550 | 550 | 550 |
| sugar (sucrose) (g) | 940 | 565 | 565 | 550 |
| glucose (g) | 280 | 75 | 75 | 90 |
| sucrose ester (g) | 1.3 | 2.9 | 2.9 | 2.9 |
| trisuc (g) | 2.3 | 2.5 | 2.5 | 2.5 |
| cocoamass* (g) | 120 | 362 | 362 | |
| lecithine | | 1.75 | 2 | |
| Cocoa powder | | | | 167 |
| Cocoa butter | | | | 195 |
| Cocoa paste** | 110 | | | |
| aroma/vanilla | 1.2 | | | |
| sum ingredients | 1674.8 | 1560.35 | 1560.6 | 1557.4 |
| prior to heating (g) | | | | |
| Boiling temperature | 124° C. | 104° C. | 104° C. | 108° C. |

*CM-CAL-552 from Callebaut ®
**60% water, 40% Cocoa powder (100014-793 from Callebaut ®)

### Further Observations Regarding the Exemplified Products

In addition to the good heat resistance shown above, the exemplified products were found to have the following characteristics:
intense taste experience
good bite
the product is not sticky
good bite
enables good moulding and covering
brownie effect: when heated in the range from 40 to 75° C., the taste of a brownie is experienced
no fat blooming observed
no sugar blooming observed
no change of taste and smell when stored near products having a strong smell (it is a known phenomenon that chocolate can—when stored near products having a strong smell—easily take over such smell).

1-66. (canceled)

67. A method for preparing a chocolate product, the process comprising:
(a) providing a mixture, said mixture comprising:
(i) one or more cocoa components;
(ii) sucrose and one or more reducing sugars; and
(iii) water,
wherein (1) said one or more cocoa components comprises cocoa butter and/or (2) said mixture comprises a chocolate compatible fat;
(b) heating said mixture at a temperature of at least 90° C. and/or heating said mixture at a temperature sufficiently high to effect evaporation of at least part of the water; and
(c) cooling the mixture resulting from (b).

68. The method according to claim 67, wherein said method further comprises (d) subjecting the mixture to a treatment, which comprises subjecting the mixture to a temperature between 30 and 40° C., for at least 1 minute and/or which treatment comprises keeping the mixture under conditions such as to induce formation of type V crystals.

69. The method according to claim 68, wherein said method further comprises aging the mixture resulting from (c) and/or (d) to obtain a heat resistant chocolate product.

70. The method according to claim 69, wherein the heat resistant chocolate product does not melt when kept in an oven at 40° C. for a period of at least 30 minutes.

71. The method according to to claim 67, wherein said cooling comprises cooling to a temperature below 40° C. and wherein cooling comprises a stage wherein cooling is effected in a vessel or in a cooling tunnel or wherein cooling is effected by contacting the mixture with a cooling surface.

72. The method according to to claim 67, wherein said cooling comprises, in a first stage, cooling the mixture resulting from (b) to a temperature of between 60 and 85° C., wherein said first stage is effected in a vessel and wherein the mixture is mechanically agitated, during at least part of said first stage and in a second stage, contacting the mixture with a cooling surface.

73. The method according to claim 68, heating the product resulting from (c) and/or (d) to a temperature of above 80° C. prior to aging.

74. The method according to claim 73, further comprising repeating (c) and/or (d) after the heating and prior to aging.

75. The method according to claim 67, wherein said one or more reducing sugars comprises one or more monosaccharides.

76. The method according to claim 75, wherein said one or more monosaccharides is glucose.

77. The method according to claim 67, wherein the mixture comprises between 25 and 70 wt. % of sucrose with respect to the weight of the mixture, excluding water and wherein, in said mixture, the ratio of sucrose to said one or more reducing sugars is between 95:5 and 50:50.

78. The method according to claim 67, wherein the mixture comprises between 5 and 60 wt. % of cocoa components with respect to the weight of the mixture, excluding water and wherein the mixture comprises 5 and 40 wt. % of cocoa butter with respect to the weight of the mixture, excluding water.

79. The method according to claim 67, wherein said treatment in (d) comprises mechanically agitating the mixture, preferably by stirring and/or kneading.

80. The method according to claim 67, wherein water is evaporated in (b), resulting in a mixture comprising less than 25 wt. % of water with respect to the weight of the mixture.

81. The method according to claim 67, wherein the method further comprises feeding the chocolate product from (c) and/or (d)) into a mould and aging the product to obtain a heat resistant chocolate product.

82. The method according to claim 67, wherein the mixture comprises milkfat, sucrose ester, trisuc, milk, cocoa powder, cocoa liquor, conched chocolate and/or combinations thereof.

83. A chocolate product comprising:
(I) one or more cocoa components;
(II) sucrose; and
(III) one or more reducing sugars;
wherein (1) said one or more cocoa components include cocoa butter and/or (2) said mixture comprises a chocolate compatible fat; and wherein said one or more reducing sugars comprises one or more monosaccharides.

84. The chocolate product according to claim 83, wherein said chocolate product comprises between 5 and 60 wt. % of cocoa components with respect to the weight of the chocolate product and between 5 and 40 wt. % of cocoa butter with respect to the weight of the chocolate product.

85. The chocolate product according to claim 83, wherein said chocolate product comprises between 25 and 70 wt. % of sucrose with respect to the weight of the chocolate product and wherein the ratio of sucrose to said one or more reducing sugars is between 95:5 and 50:50.

86. The chocolate product according to claim 83, wherein said one or more monosaccharides is glucose.

87. The chocolate product according to claim 83, wherein the heat resistant chocolate product does not melt when kept in an oven at 40° C. for a period of at least 30 minutes.

88. The chocolate product according to claim 83, wherein the mixture comprises milkfat, sucrose ester, trisuc, milk, cocoa powder, cocoa liquor, conched chocolate and/or combinations thereof.
